(19) United States
(12) Patent Application Publication
(10) Pub. No.: US 2008/0234613 A1
(43) Pub. Date: Sep. 25, 2008

(54) Massage Carriage

(75) Inventor: Uwe Schefthaler, Taufkirchen/Vils (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: OKIN GESELLSCHAFT FUR ANTRIEBSTECHNIK MBH, Gummersbach (DE)

(21) Appl. No.: 10/598,342

(22) PCT Filed: Feb. 24, 2005
(86) PCT No.: PCT/DE05/00321

§ 371 Date: Jun. 2, 2008

(30) Foreign Application Priority Data
Feb. 25, 2004 (DE) 20 2004 003 067.5

(51) Int. Cl. A61H 7/00

(52) U.S. Cl. 601/100

(57) ABSTRACT

A massage carriage comprises a drive (1), a first shaft that can be moved by the drive (1) and a second shaft that can be moved by the drive (1), two first arms (3), which are connected to the first shaft, can be moved by the first shaft and on each of which a massage element (4) is mounted, and two second arms (6), which are connected to the second shaft and can be moved by the second shaft, one of which each acts on one of the first arms (3). To relieve the back of the person using the chair when the massage function of a massage chair is not in use, or when the backrest is moved far backwards or downwards, the length of the second arms (6), i.e. the distance between the point of connection to the second shaft and the point of action on the respective first arm (3), is adjustable.

The invention relates to a massage carriage for use in a massage chair or similar that can be moved back and forth along a frame in the massage chair or similar, comprising a drive, a first shaft that can be moved by the drive and a second shaft that can be moved by the drive, two first arms, which are connected to the first shaft, can be moved by the first shaft and on each of which a massage element is mounted, and two second arms, which are connected to the second shaft and can be moved by the second shaft, one of which each acts on one of the first arms, such that the massage elements can be moved by the drive with one movement component oriented parallel to the frame and one oriented perpendicular to the frame.

Massage carriages of this kind are known in various designs. In the case of customary use of a massage carriage in the backrest of a massage chair or similar, the two shafts movable by the drive are arranged horizontally and one above the other, e.g. the first shaft above the second shaft. As a rule, the two shafts display eccentric areas at their ends, on which the first or second arms are mounted. In this context, the eccentric area on the ends of the first shaft can be angled relative to this shaft, such that, when the first shaft is rotated, the first arms bearing the massage elements perform a pivoting movement about an essentially horizontal axis that passes through the intersection of the first shaft and the angled axis of the eccentric areas. The massaging action generated by this movement of the massage elements is referred to as “kneading”.

The movement of the second shaft is such that, via its connection by the second arms to the first arms and the movement of the first arms by the first shaft, an essentially vertical movement of the massage elements is generated, possibly with a component oriented perpendicular to the “kneading” movement. The massage action exerted by this movement is also referred to as “tapping”.

To generate the “tapping”, the second shaft can, like the first shaft, be provided with eccentric areas on its ends, to which the second arms are connected in articulated fashion. Like the first shaft, the second shaft is then rotated by the drive. Instead of rotation, however, other forms of movement are also open to consideration, especially for the second shaft, being induced by the drive and enabling the “kneading” and “tapping” movements of the massage elements described above.

A massage carriage of the type mentioned in the opening paragraph is known from WO 97/37627, where the upper, first shaft and the lower, second shaft are driven by an upper and a lower geared motor. The first arms, connected in articulated fashion on the angled, eccentric areas of the first shaft, extend essentially in a horizontal direction from the two geared motors. The free ends of the second arms act on the middle areas of the first arms in articulated fashion, said second arms being connected to the eccentric areas of the second shaft and moved by it.

Owing to this design, the known massage carriage is relatively expansive, especially in the horizontal direction. Its installation, e.g. in the backrest of a massage chair, thus requires a correspondingly large installation depth, in which context the massage carriage is inserted through an opening on the rear side of the backrest of the massage chair. The opening can be closed by means of an externally visible flap.

When the massage function in the backrest of a chair or another item of furniture is not in use, the massage elements of the known massage carriage interfere when in their idle position, in that they cause unpleasant pressure on the back when a person leans back in the chair. The massage elements can also have an unpleasant or even harmful effect on the back when the chair back is moved far backwards or downwards, particularly as a result of a high body weight.

The object of the present invention is to develop a massage carriage of the kind mentioned in the opening paragraph in such a way that it can easily be installed in the backrest of a massage chair or another item of furniture, and that it relieves the back of a person using the chair when the massage function is not in use, or when the chair back is moved far backwards or downwards.

According to the invention, the object is solved in that, on a massage carriage of the kind mentioned in the opening paragraph, the length of the second arms, i.e. the distance between the point of connection to the second shaft and the point of action on the respective first arm, is adjustable.

While the second arms are set to their full length as the massage carriage travels up and down along the frame in normal massaging mode, their length can be reduced when the massage function is stopped, the result being that the first arms, which project essentially horizontally, are swung towards the second shaft. This reduces the horizontal distance between the massage elements and the drive for the two shafts.

When the first arms and the attached massage elements are retracted in this way, the massage carriage takes on relatively flat dimensions in a parking mode of this kind, such that it can be inserted into the backrest of a massage chair in the longitudinal direction from below. Following installation, the first arms with the massage elements can then be extended when the massage function is activated.

When the massage function is not in use, the first arms and the massage elements mounted on them can be retracted, thereby avoiding what is perceived as unpleasant pressure on the back of the person sitting in the chair.

If it is ensured that the length of the second arms is reduced in the event of a high load, resulting from a high body weight or the seat back being moved far backwards or downwards, the retracted second arms form a kind of overload protection for the human back. Unpleasant or even harmful action of the massage elements on the back is avoided, particularly if the length of the second arms is reduced automatically in the event of extreme loading.

In a preferred embodiment of the invention, the first arms are designed, and the first and second arms arranged, in such a way that the length of the second arms can be reduced by applying a predetermined pressure on the side of the first arms facing away from the second arms, against an initial tension. In the event of greater loading of the massage elements and the first arms, the second arms are compressed, such that the back is relieved and health damage avoided. When the load is relieved, the second arms automatically extend back into the normal massaging position owing to the initial tension.

This function can particularly be achieved by the first arms being designed, and the first and second arms arranged, in such a way that the length of the second arms can be reduced by applying a predetermined pressure to the side of the massage elements facing away from the first arms, against an initial tension.

In a preferred embodiment, the second arms display telescopic parts, such that their length can easily be adjusted by retracting and extending these parts.

In this context, the second arms can expediently be designed as pneumatic springs.

In a further embodiment, the second arms can be designed as telescopic spring elements.

Other expedient embodiments of the second arms that permit adjustment of their length are also open to consideration. For example, the second arms can also display a toggle link.

So that the second arms automatically extend again when the load is relieved, a spring element acting against the reduction of the length of the second arms can expediently be provided. This also makes it possible, during a normal massage, to achieve gentle adaptation of the first arms with the massage elements to the contour of the back of the person using the massage chair. If, for example, pneumatic springs are used for the second arms, they and the spring element must be matched in order to achieve this action. Similarly, telescopic spring elements or spring-assisted toggle links can be used for the second arms.

To have the first arms with the massage elements retract when the massage carriage reaches a certain position on the frame, a mechanical or electric trigger element can be provided, whose actuation allows the length of the second arms to be reduced.

The invention furthermore relates to a massage unit, comprising a massage carriage of the kind described above and a frame along which the massage carriage can be moved.

To actuate the aforementioned mechanical or electrical trigger element, an operating element located on the frame can be provided, by means of which the trigger element can be actuated when a predetermined position of the massage carriage on the frame is reached.

The operating element is preferably located in the region of one end of the travel path of the massage carriage along the frame, and designed to apply pressure to the first arms in the direction of the second arms.

In particular, the operating element can display two rollers, skids or similar in the direction of travel of the first arms of the massage carriage, by means of which the first arms can be pressed towards the second arms when the rollers, skids or similar are reached, where the length of the second arms can be reduced by a pressure component acting in their longitudinal direction.

In this context, the massage unit can display a cutoff device, upon actuation of which the massage carriage is moved to the end of the travel path, where the first arms are pressed against the operating element over a defined distance at the end of the travel path, where the massage elements can be retracted towards the frame due to the resultant shortening of the second arms.

A sensor system can switch off the drive of the massage elements upon reaching a predetermined position of the massage carriage, before the first arms are pressed against the operating element. The massage carriage thereafter continues to be moved over the distance defined above, in which context the operating element, e.g. the rollers, skids or similar, press the first arms downwards. Due to the resultant shortening of the second arms, the massage elements are retracted towards the frame and no longer interfere in the area of the back.

Practical examples of the invention are described in more detail below on the basis of the drawing. The Figures show the following:

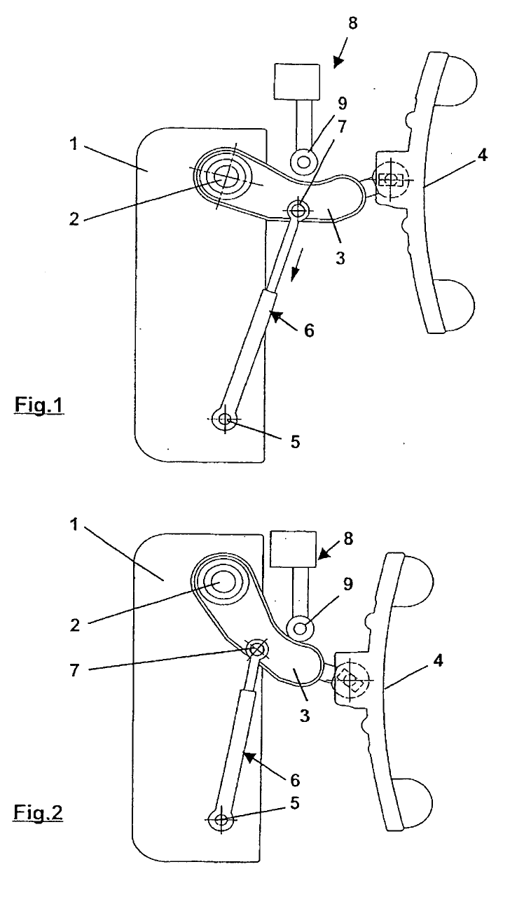

FIG. 1 A side view of a practical example of the massage carriage, in massaging mode,

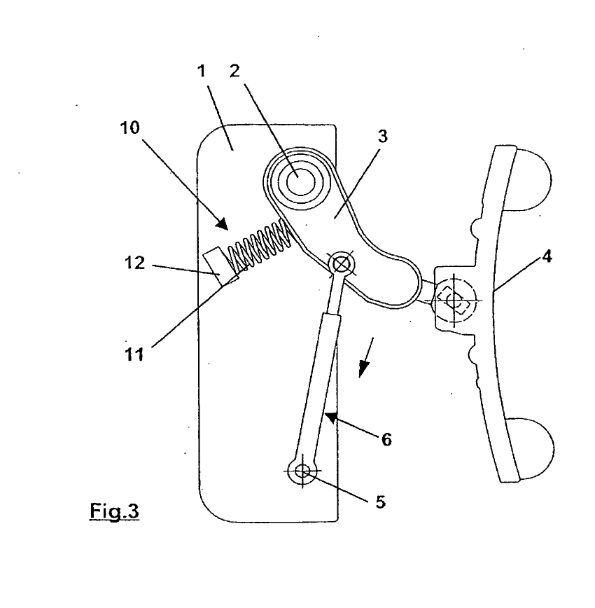

FIG. 2 A side view of the massage carriage according to FIG. 1, in parking mode,

FIG. 3 A side view of a second practical example of the massage carriage, in parking mode,

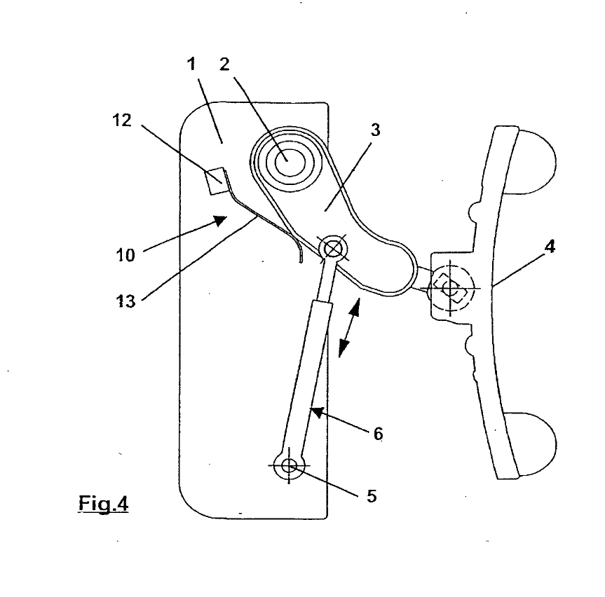

FIG. 4 A side view of a third practical example of the massage carriage, in parking mode,

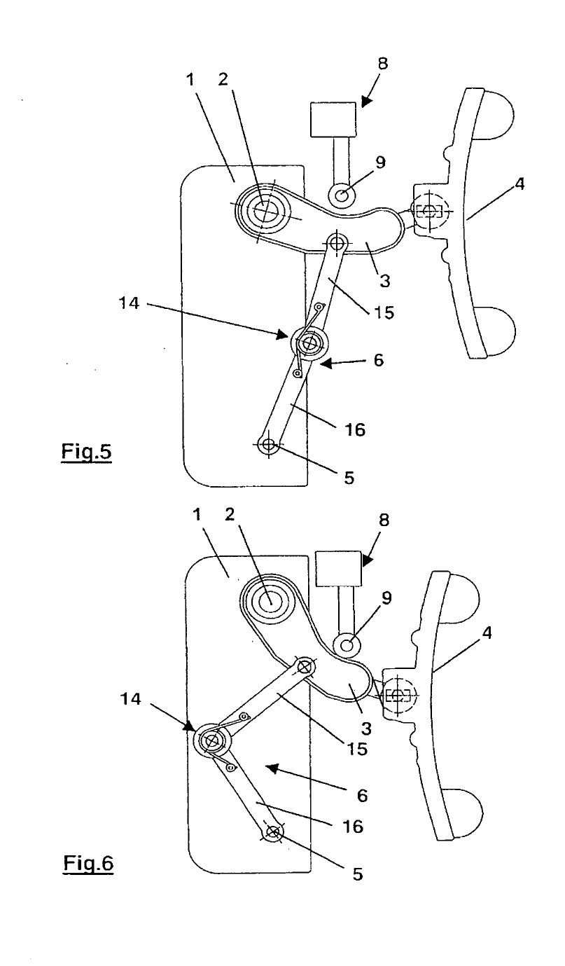

FIG. 5 A side view of a fourth practical example of the massage carriage, in massaging mode, and

FIG. 6 A side view of the practical example of a massage carriage illustrated in FIG. 3, in parking mode.

As can be seen from the drawing, a massage carriage for use in a massage chair or similar, which can be moved back and forth along a frame in the massage chair or similar, displays a drive 1 with a first shaft that can be moved by the drive, and a second shaft that can be moved by the drive (these not being shown in detail in the drawing). Located on both ends of the first shaft are eccentric areas 2, which are angled relative to the shaft. Two first arms 3 are mounted freely in terms of the sense of rotation on angled, eccentric areas 2. The free ends of arms 3 bear massage elements 4. The drawing in each case shows only one first arm 3 with attached massage element 4 on one side of drive 1.

The second shaft, moved by drive 1, likewise displays eccentric areas 5 on its two ends, on which two second arms 6 are freely mounted in a ball-and-socket joint. The free ends of second arms 6 act on the middle area of first arms 3 via an articulated connection 7.

Drive 1 can comprise one motor, e.g. a motor with integrated clutch, for driving both shafts, or two motors for driving one shaft each, as well as a reduction gear for transmitting power from the motor shaft to the shafts.

When the first shaft is rotated by the associated motor, the two first arms 3 are, owing to eccentric areas 2 being angled relative to the shaft, set into pivoting motion in an essentially vertical plane about a horizontal axis that passes through the intersection of the first shaft and the axis of corresponding eccentric area 2, angled relative to the shaft. This movement of first arms 3 induces the “kneading” movement of massage elements 4.

The motor-driven second shaft can likewise be rotated by the motor to operate second arms 6.

Owing to the eccentric mounting of first and second arms 3 and 6 relative to the motor-driven shafts, rotation of the first and second shafts generates essentially vertical back-and-forth motion of first arms 3, possibly with an additional, horizontal movement component. This oscillation of first arms 3 generates the “tapping” movement of massage elements 4. This “tapping” movement is superimposed on the “kneading” movement generated by the pivoting movement of the first arms in an essentially vertical plane.

The “kneading” and “tapping” movements can be activated separately by setting the sense of rotation and speed of the motor, or by setting the sense of rotation of the motor and disconnecting or connecting the first shaft, in which context the two functions can also be performed simultaneously.

To be able to retract first arms 3, and massage elements 4 mounted on them, towards drive 1 into a parking position, the length of second arms 6 is adjustable, i.e. the distance between articulated connection 7 to first arms 3 and the articulated connection to eccentric areas 5 of the second shaft.

In the practical example shown in FIGS. 1 and 2, second arms 6 are designed as pneumatic springs. In normal massaging mode, as illustrated in FIG. 1, the massage carriage travels up and down along the back of the person sitting in the massage chair or similar. Via the extended pneumatic spring shown in FIG. 1, the “tapping” movement of rotating eccentric areas 5 of the second shaft is transmitted to first arms 3 and thus to massage elements 4. A relatively strong pneumatic spring (e.g. 400 N) is preferred for effective transmission of the “tapping” movement.

The massage carriage can be moved up and down in an essentially vertical direction along a frame (not shown in the drawing) installed in the backrest of a massage chair, for example. As shown in FIGS. 1 and 2, an operating element is located at the upper end of the frame, i.e. in the region of the upper end of the travel path of the massage carriage, in the direction of travel of first arms 3. If the massage carriage travels upwards beyond the position illustrated in FIG. 1, operating element 8 exerts pressure on the first arms in the direction of second arms 6. As a result, first arms 3 are swung downwards, and second arms 6, designed as pneumatic springs, are compressed until the position of the massage carriage shown in FIG. 2 is reached. In this position, first arms 3 with massage elements 4 are retracted towards drive 1 over a defined distance, which can amount to several centimeters, such that the massage carriage assumes a compact form in the horizontal direction. In this parking mode, it no longer interferes in the back area, and can be inserted into the backrest of a massage chair in this compact form, e.g. from below.

As can further be seen from FIGS. 1 and 2, operating element 8 displays rollers 9, which interact with the upper edge of first arms 3.

When the position of the massage carriage illustrated in FIG. 1 is reached, a sensor system not shown in the drawing can switch off the massage function, i.e. the drive of the first and second shafts, and move the massage carriage upwards over a defined distance, in which context roller 9 of operating element 8 guides first arms 3 and massage elements 4 into the parking position.

When the massage function is switched on, the massage carriage is moved down again over the defined distance, out of the parking position shown in FIG. 2, until it reaches the position shown in FIG. 1. In this context, relief of the pressure on the pneumatic spring causes first arms 3 with massage elements 4 to move upwards, such that massage elements 4 are extended into massaging position. The drive is switched on, and the massage function thus activated, via the sensor system in this position.

FIGS. 3 and 4 show an additional spring element 10, acting against the pneumatic spring, by means of which the spring force of the pneumatic spring is increased. Spring element 10 thus supports extension of the pneumatic spring from the parking position of first arms 3 and massage elements 4, shown in FIGS. 3 and 4, into the massaging position.

Spring element 10 also makes it possible to achieve gentle adaptation of massage elements 4 to the contour of the human back during the massage. The pneumatic spring and spring element 10 must be matched to each other for this purpose.

Spring element 10 shown in FIG. 3 is designed as a coil spring 11, one end of which is fastened to a projection integrally molded on the side of the housing of drive 1, the other end acting on the underside of first arm 3.

In the embodiment shown in FIG. 4, spring element 10 comprises a leaf spring 13, one end of which is likewise fastened to a projection integrally molded on the side of the housing of drive 1, the other end resting against the underside of first arm 3 under initial tension.

FIGS. 5 and 6 shown a practical example in which second arm 6 displays a spring-assisted toggle link 14.

If pressure is exerted on first arms 3 via roller 9 of operating element 8, or via massage elements 4 by bodily force, the two parts 15 and 16 of second arms 6, connected to each other via toggle link 14, are angled relative to each other against the spring force, such that first arms 3 are swung inwards towards drive 1 and massage elements 4 can be retracted.

### LIST OF REFERENCE NUMBERS

1 Drive
2 Eccentric area
3 First arm
4 Massage element
5 Eccentric area
6 Second arm
7 Articulated connection
8 Operating element
9 Roller
10 Spring element
11 Coil spring
12 Projection
13 Leaf spring
14 Spring-assisted toggle link
15 Part
16 Part

1. Massage carriage for use in a massage chair or similar that can be moved back and forth along a frame in the massage chair or the like, comprising a drive (1), a first shaft that can be moved by the drive (1) and a second shaft that can be moved by the drive (1), two first arms (3), which are connected to the first shaft, can be moved by the first shaft and on each of which a massage element (4) is mounted, and two second arms (6), which are connected to the second shaft and can be moved by the second shaft, one of which each acts on one of the first arms (3), such that the massage elements (4) can be moved by the drive (1) with one movement component oriented parallel to the frame and one oriented perpendicular to the frame where the effective length of the second arms (6), i.e., the distance between the point of connection to the second shaft and the point of action on the respective first arm (3), is adjustable, characterized in that the first arms (3) are designed, and the first and second arms (3, 6) arranged, in such a way that the effective length of the second arms (6) can be reduced by applying a predetermined pressure on the side of the first arms (3) facing away from the second arms and/or on the side of the massage elements (4) facing away from the first arms (3), against an initial tension.

2-3. (canceled)

4. Massage carriage according to claim 1, characterized in that the second arms (6) display telescopic parts.

5. Massage carriage according to claim 4, characterized in that the second arms (6) are designed as pneumatic springs.

6. Massage carriage according to claim 1, characterized in that the second arms (6) are designed as telescopic spring elements.

7. Massage carriage according to claim 1, characterized in that the second arms display a toggle link (14).

8. Massage carriage according to claim 1, characterized in that a spring element (10) acting against the reduction of the length of the second arms is provided.

9. Massage carriage according to claim 1, characterized in that a mechanical or electric trigger element is provided, whose actuation allows the length of the second arms (6) to be reduced.

10. Massage unit, with a massage carriage according to claim 9 and a frame along which the massage carriage can be moved, characterized by an operating element (8) located on the frame, by means of which the trigger element can be actuated when a predetermined position of the massage carriage on the frame is reached.

11. Massage unit according to claim 10, characterized in that the operating element (8) is located in the region of one end of the travel path of the massage carriage along the frame, and designed to apply pressure to the first arms (3) in the direction of the second arms (6).

12. Massage unit according to claim 10, characterized in that the operating element (8) displays two rollers (9) in the direction of travel of the first arms (3) of the massage carriage, by means of which the first arms (3) can be pressed towards the second arms (6) when the rollers (9) are reached, where the length of the second arms (6) can be reduced by a pressure component acting in their longitudinal direction.

13. Massage unit according to claim 11, characterized by a cutoff device, upon actuation of which the massage carriage is moved to the end of the travel path, where the first arms (3) are pressed against the operating element (8) over a defined distance at the end of the travel path, where the massage elements (4) can be retracted towards the frame due to the resultant shortening of the second arms (6).

14. Massage unit according to claim 13, characterized by a sensor system, by means of which the drive (1) of the massage elements (4) can be switched off upon reaching a predetermined position of the massage carriage, before the first arms (3) are pressed against the operating element (8).
